(19) United States
(12) Patent Application Publication
(10) Pub. No.: US 2011/0277451 A1
(43) Pub. Date: Nov. 17, 2011

(54) CONTROL UNIT FOR MULTI-CYLINDERED INTERNAL COMBUSTION ENGINE

(75) Inventors: Shinichi HOSHINO, Toyota-shi (JP); Isao NAKAJIMA, Toyota-shi (JP); Tatsuro SHIMADA, Toyota-shi (JP); Sei MARUTA, Toyota-shi (JP)

(73) Assignee: TOYOTA JIDOSHA KABUSHIKI KAISHA, Toyota-shi (JP)

(21) Appl. No.: 13/088,805

(22) Filed: Apr. 18, 2011

(30) Foreign Application Priority Data
May 13, 2010 (JP) 2010-110760

(51) Int. Cl. F02D 43/00

(52) U.S. Cl. 60/285

(57) ABSTRACT

The “imbalance index value” representing the magnitude of the difference among the cylinder-by-cylinder air-fuel ratios (imbalance of air-fuel ratios among cylinders) is acquired based on the output value of the air-fuel ratio sensor disposed above the catalyst. The execution of the emission reduction control is “limited” when the magnitude of the imbalance of air-fuel ratios among cylinders represented by the imbalance index value is the first degree or more, and less than the second degree which is larger than the first degree, and is “prohibited” when it is the second degree or more. As the emission reduction control, a purge control, an EGR control, an Al incremental control, a cold VVT control, a catalyst warm-up delay angle control, an SCV control, and the like can be exemplified. Misfire due to the execution of emission reduction control are suppressed, when the imbalance of air-fuel ratios among cylinders occurs.

### BACKGROUND OF THE INVENTION

1. Field of the Invention

The present invention relates to a control unit for a multi-cylindered internal combustion engine.

2. Description of the Related Art

Conventionally, an air-fuel ratio control unit for feedback controlling an air-fuel ratio in the gas (mixed exhaust gas) passing through a gathering exhaust channel composed of gathered respective exhaust channels extending from multiple cylinders, based on an output value of an air-fuel ratio sensor disposed in the gathering exhaust channel is widely known. The mixed exhaust gas is gas obtained by mixing exhaust gases exhausted from respective cylinders. More specifically, in this air-fuel ratio control unit, an air-fuel ratio feedback amount which is common to multiple cylinders is calculated based on the output value of the air-fuel ratio sensor. Based on the air-fuel ratio feedback amount, the amounts of fuel to be respectively injected into the multiple cylinders are adjusted, and thereby, the air-fuel ratio in the mixed exhaust gas is feedback controlled.

Also, various types of controls for reducing emission (emission reduction control) have been proposed, corresponding to the fact that regulation on the emission of hazardous substances emitted from a vehicle mounting an internal combustion engine thereon due to the internal combustion engine has been getting stricter recently. Specifically, for example, control for adjusting the opening and closing timings of intake valves and/or exhaust valves of an internal combustion engine during the warming-up of the internal combustion engine to increase the spit-back amount of high-temperature burned gas in combustion chamber and decrease the amount of fuel injection (cold VVT control), as well as control for delaying the ignition timing of ignition plugs of an internal combustion engine during the warm-up of the internal combustion engine (catalyst warm-up delay angle control), and the like can be exemplified.

In the cold VVT control, the temperature of an intake channel is increased to promote the atomization of liquid fuel adhering to the intake channel, and thereby the amount of fuel contributing to combustion is increased. Corresponding to the increment, the amount of fuel injection is decreased. Thereby, the amount of unburned materials (HC, CO) emitted outside decreases. In the catalyst warm-up delay angle control, the timing of fuel burning is delayed to increase the temperature of exhaust gas. Thereby, the warm-up of the three-way catalyst is promoted to decrease the amount of unburned materials (HC, CO) and nitrogen oxides (NOx) emitted outside.

By the way, in a multi-cylindered internal combustion engine, variability of injection amounts from fuel injection valves among cylinders, variability of maximum lifting heights of intake valves among cylinders, and variability of distribution of EGR gas circulated to an intake system by means of EGR mechanism into multiple cylinders can occur. When such variability of properties among cylinders occurs, variability of air-fuel ratio among cylinders (air-fuel ratio imbalance among cylinders, air-fuel ratio variability among cylinders, and air-fuel ratio unevenness among cylinders) can occur. For example, in Japanese Patent Application Laid-Open (kokai) No. 2009-264287, it is described to execute a predetermined catalyst degradation suppression control in accordance with the degree of the air-fuel ratio imbalance among cylinders to suppress the degradation of catalyst.

### SUMMARY OF THE INVENTION

In case where an air-fuel ratio imbalance among cylinders occurs, even though, by means of the above-mentioned air-fuel feedback control, the air-fuel ratio in the mixed exhaust gas (i.e., average of the air-fuel ratios for all cylinders) coincides with the theoretical air-fuel ratio, a cylinder with an air-fuel ratio richer (than the theoretical air-fuel ratio) (rich cylinder) and a cylinder with an air-fuel ratio leaner (than the theoretical air-fuel ratio) (lean cylinder) necessarily occur.

Now, assume the case where the emission reduction control is executed when the air-fuel ratio imbalance among cylinders occurs. For example, when the cold VVT control is executed, especially in the lean cylinder with low combustion limit, problems such as excessively lean air-fuel ratio due to the decrease in the amount of fuel injection causing misfire and the like can occur. Similarly, also when the catalyst warm-up delay angle control is executed, especially in the lean cylinder with low combustion limit, problems such as excessively instable combustion due to the delay of ignition timing causing misfire and the like can occur.

The present invention has been made for addressing the above problems, and the object thereof is to provide a control unit for a multi-cylindered internal combustion engine which can suppress the occurrence of misfire and the like due to the execution of the emission reduction control.

The control unit for a multi-cylindered internal combustion engine for achieving such an object according to the present invention (the present control unit) is applied to a multi-cylindered internal combustion engine having multiple cylinders. The present control unit comprises an air-fuel ratio sensor, multiple fuel injection valves, a feedback amount calculation means, a feedback control means, and a reduction control execution means.

Said air-fuel ratio sensor is disposed in said gathering exhaust channel, and generates an output value corresponding to the air-fuel ratio in said mixed exhaust gas.

Said multiple fuel injection valves are disposed in accordance with each of said multiple cylinders. Said multiple fuel injection valves respectively inject fuel contained in an air-fuel mixture supplied to each combustion chamber of said multiple cylinders. Namely, one or more fuel injection valves are set for one cylinder. Each fuel injection valve injects fuel to its corresponding cylinder.

Said feedback amount calculation means calculates an air-fuel ratio feedback amount which is common to said multiple cylinders. This air-fuel ratio feedback amount is calculated based on the output value of said air-fuel ratio sensor so that the air-fuel ratio in said mixed exhaust gas coincides with the theoretical air-fuel ratio.

Said feedback control means adjusts the amounts of fuel to be respectively injected from each of said multiple fuel injection valves based on said air-fuel ratio feedback amount. Thereby, the air-fuel ratio in said mixed exhaust gas is feedback controlled.

Said reduction control execution means executes said emission reduction control for reducing emission. As the emission reduction control, for example, the above-mentioned cold VVT control, catalyst warm-up delay angle control, and the like can be exemplified. In addition, a purge control, an EGR control, an Al incremental control, and the like can be exemplified.

One of the features of the present control unit is in that it comprises an imbalance index value acquisition means. Said imbalance index value acquisition means acquires an imbalance index value. The imbalance index value is a value that increases or decreases (value that monotonically increases or decreases) in accordance with the increase in the degree of discrepancy (degree of difference, disbalance) among the “multiple cylinder-by-cylinder air-fuel ratios” which are the “air-fuel ratios in air-fuel mixtures supplied into respective combustion chambers of said multiple cylinders” and it is a value obtained based on the output value of said air-fuel ratio sensor. Hereinafter, the degree of discrepancy (degree of difference, disbalance) among the “multiple cylinder-by-cylinder air-fuel ratios” may be referred to as a “degree of imbalance of air-fuel ratios among cylinders.”

Said imbalance index value includes the locus length of the output values of the air-fuel ratio sensor, the locus length of air-fuel ratio represented by the output values of the air-fuel ratio sensor (detected air-fuel ratio) and the like. On the contrary, it is suitable to configure to acquire, as said imbalance index value, a value based on the temporal differential value of said detected air-fuel ratio. The temporal differential value of the detected air-fuel ratio is unlikely to be affected by engine revolution speed, as compared with the locus length of the detected air-fuel ratio. Therefore, according to the above-described configuration, an index value unlikely to be fluctuated by engine revolution speed can be obtained. As the result of this, regardless of engine revolution speed, the degree of imbalance of air-fuel ratios among cylinders can be stably and accurately acquired.

Another one of the features of the present control unit is in that said reduction control execution means limits the execution of said emission reduction control when said degree of discrepancy represented by said imbalance index value is large, as compared with when said degree of discrepancy is small.

The larger the degree of imbalance of air-fuel ratios among cylinders is, the larger the degree of richness in the above-mentioned rich cylinder and the degree of leanness in the above-mentioned lean cylinder become. Therefore, for example, during the execution of the cold VVT control or catalyst warm-up delay angle control, The larger the degree of imbalance of air-fuel ratios among cylinders is, the more likely to occur misfire and the like in the lean cylinder.

In this point, according to the above-described configuration, when the degree of imbalance of air-fuel ratios among cylinders is large, the execution of the emission reduction control is limited. Specifically, for example, in the cold VVT control, the decrement of the amount of fuel injection is decreased, and in the catalyst warm-up delay angle control, the delayed angle amount of ignition timing is decreased. Therefore, misfire becomes more unlikely to occur. Namely, when the imbalance of air-fuel ratios among cylinders occurs, misfire and the like due to the execution of the emission reduction control can be suppressed.

The present control unit can be configured so as to limit the execution of said emission reduction control when the degree of imbalance of air-fuel ratios among cylinders is the first degree or more, and less than the second degree which is larger than said first degree, and to prohibit the execution of said emission reduction control when the degree of imbalance of air-fuel ratios among cylinders is said second degree or more. Thereby, in accordance with the degree of imbalance of air-fuel ratios among cylinders, the degree of limitation of the emission reduction control can be appropriately set.

### BRIEF DESCRIPTION OF THE DRAWINGS

FIG. 1 is a figure showing schematic configuration of multi-cylindered internal combustion engine to which the control unit according to an embodiment of the present invention is applied.

FIG. 2 is a figure for describing the inside of the intake channel adjacent to the SCV shown in FIG. 1.

FIG. 3 is a figure for describing the purge control mechanism which the internal combustion engine shown in FIG. 1 comprises.

FIG. 4 is a figure for describing the Al incremental control mechanism which the internal combustion engine shown in FIG. 1 comprises.

FIG. 5 is a figure showing the situation where the catalyst, upstream air-fuel ratio sensor, and downstream air-fuel ratio sensor shown in FIG. 1 are disposed in the gathering exhaust channel.

FIG. 6 is a graph showing the relation between the output values of the upstream air-fuel ratio sensor shown in FIG. 1 and the air-fuel ratios.

FIG. 7 is a graph showing the relation between the output values of the downstream air-fuel ratio sensor shown in FIG. 1 and the air-fuel ratios.

FIG. 8 is a figure showing an example of air-fuel ratios in respective cylinders when the imbalance of air-fuel ratio among cylinders occurs and the air-fuel ratio in the mixed exhaust gas coincides with the theoretical air-fuel ratio.

FIG. 9 is a time chart showing the behavior of each of the values associated with imbalance index value in the case where the imbalance of air-fuel ratio among cylinders occurs and that in the case where the imbalance of air-fuel ratio among cylinders does not occur.

FIG. 10 is a flowchart showing the routine executed by the CPU shown in FIG. 1.

### DESCRIPTION OF THE PREFERRED EMBODIMENTS

Hereinafter, referring to the drawings, the control unit for multi-cylindered internal combustion engine according to the present invention (hereinafter, may be referred to simply as “the present unit”) will be described.

(Configuration)

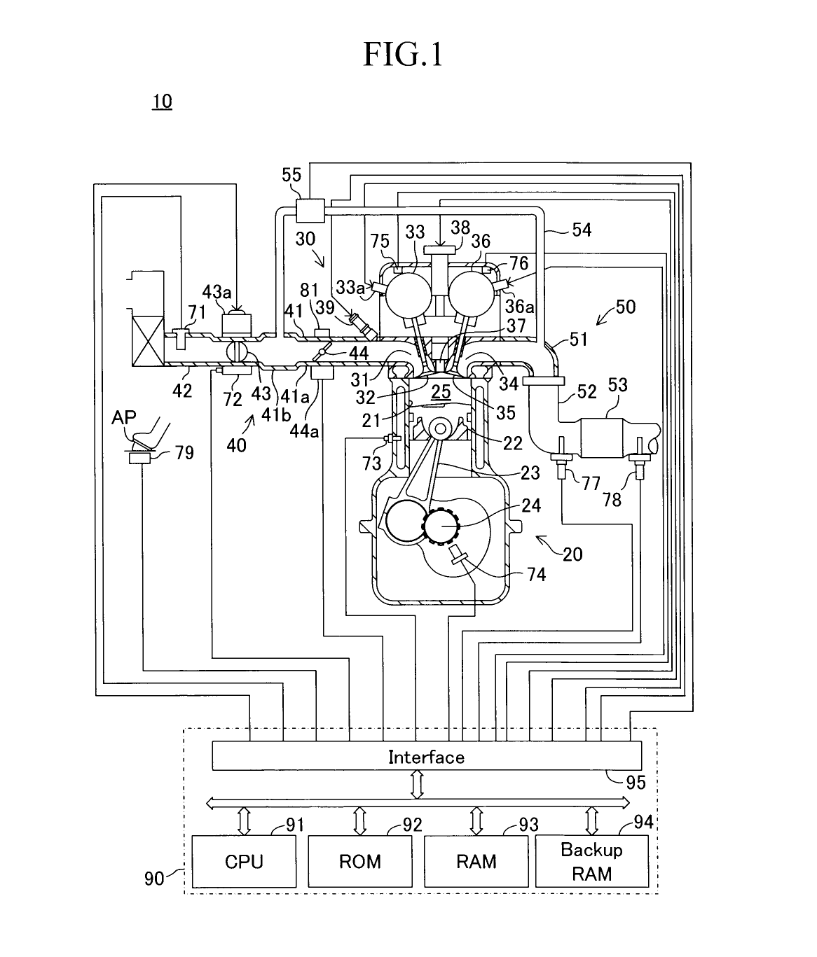

FIG. 1 shows a schematic configuration of a system wherein the present unit is applied to 4-cycle spark-ignited multi-cylindered (in-line four-cylinder) internal combustion engine 10. Although FIG. 1 shows only the cross-section of a certain cylinder, other cylinders also have similar configuration.

The internal combustion engine 10 comprises a cylinder block portion 20 comprising a cylinder block, a cylinder block lower case, oil pan and the like, a cylinder head portion 30 fixed on the cylinder block portion 20, an intake system 40 for supplying gasoline-mixed air to the cylinder block portion 20, and an exhaust system 50 for emitting exhaust gas from the cylinder block portion 20 to outside.

The cylinder block portion 20 comprises a cylinder 21, a piston 22, a connecting rod 23 and crank shaft 24. They are configured so that the piston 22 moves in a reciprocating manner within the cylinder 22, and the reciprocating movement of the piston 22 is transmitted to the crank shaft 24 via the connecting rod 23, and thereby the crank shaft 24 rotates. The wall surface of the cylinder 21 and the upper surface of the piston 22 form a combustion chamber along with the lower surface of the cylinder head portion 30.

The cylinder head portion 30 comprises an intake port 31 in communication with the combustion chamber 25, an intake valve 32 for opening and closing the intake port 31, a variable intake timing control unit 33 comprising an intake cam shaft for driving the intake valve 32 for continuously changing the phase angle of the intake cam shaft, an actuator 33a for the variable intake timing control unit 33, an exhaust port 34 in communication with the combustion chamber 25, an exhaust valve 35 for opening and closing the exhaust port 34, a variable exhaust timing control unit 36 comprising an exhaust cam shaft for driving the exhaust valve 35 for continuously changing the phase angle of the exhaust cam shaft, an actuator 36a for the variable exhaust timing control unit 36, an ignition plug 37, an igniter 38 comprising an ignition coil for generating high voltage given to the ignition plug 37, and a fuel injection valve (fuel injection means, fuel supply means) 39 for injecting fuel into the intake port 31. Thus, the internal combustion engine 10 comprises “Variable Valve Timing (VVT) system” for changing the timing for opening and closing the intake valve 32 and exhaust valve 35.

One fuel injection valve 39 is disposed for each combustion chamber 25. The fuel injection valve 39 is disposed in the intake port 31. Thus, each of the multiple cylinders comprises a fuel injection valve 39 for supplying fuel independently from other cylinders.

The intake system 40 comprises an intake manifold 41, an intake pipe 42, a throttle valve 43, and a swirl control valve (SCV) 44. The intake manifold 41 comprises multiple branch portions 41a and a surge tank 41b. One end of each of the multiple branch portions 41a is connected to each of the multiple intake ports 31. Other ends of the multiple branch portions 41a are connected to the surge tank 41b. One end of the intake pipe 42 is connected to the surge tank 41b. The intake ports 31, the intake manifold 41 and the intake pipe 42 constitute an intake channel.

The throttle valve 43 is configured so as to vary the open cross-section area of the intake channel (throttle valve opening) in the intake pipe 42. The throttle valve 43 is configured so as to be rotationally driven within the intake pipe 42 by a throttle valve actuator 43a (part of a throttle valve drive means).

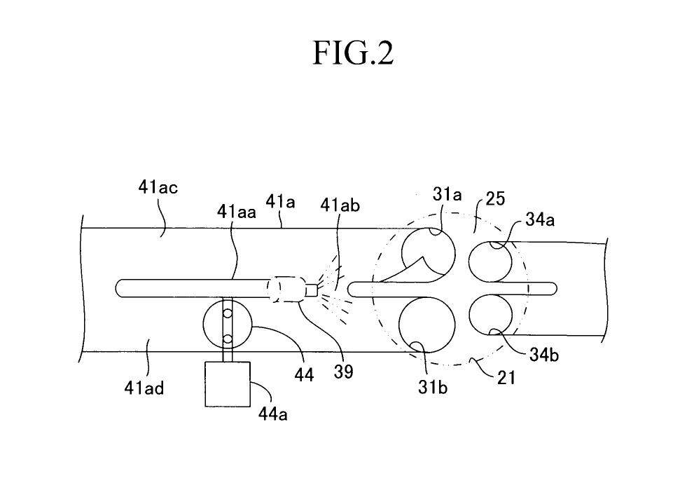

The SCV 44 is configured so as to be rotationally driven within each of the branch portions 41a by an SCV actuator 44a. As shown in FIG. 2, each intake port 31 consists of intake ports 31a and 31b practically. The intake port 31a is helically formed so as to generate swirl (swirl flow) within the combustion chamber 25 to constitute a so-called swirl port, and the intake port 31b constitutes a so-called straight port.

In each branch portion 41a, a division wall 41 as extending along the longitudinal direction of the intake pipe 42 is formed, and thereby each branch portion 41a is divided into the first intake manifold 41ac in communication with the intake port 31a and the second intake manifold 41ad in communication with the intake port 31b. The SCV 44 is supported in a rotatable manner within the second intake manifold 41ad, and is configured so as to be able to vary the open cross-section area of the second intake manifold (SCV opening) in the intake pipe 42.

In addition, at a proper point in the division wall 41aa, a communicating channel 41ab is formed to make the first and second intake manifolds 41ac and 41ad in communication with each other. An injector 39 is fixed adjacent to the communicating channel 41ab, and is configured so as to inject fuel toward he intake ports 31a and 31b. Thus, the internal combustion engine 10 comprises an “intake flow adjusting system” to adjust intake flow by adjusting the opening of the SCV 44.

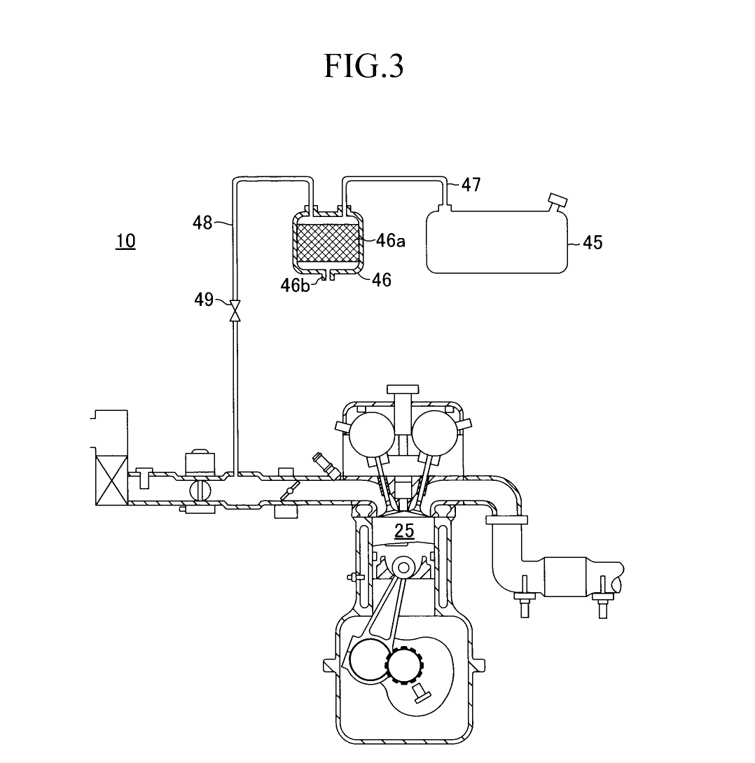

As shown in FIG. 1 and FIG. 3, the internal combustion engine 10 comprises a fuel tank 45 to retain liquid gasoline fuel, a canister (charcoal canister) 46 capable of absorbing the fuel gas generated by the evaporation of the fuel retained in the fuel tank 45, a vapor collection pipe 47 for conducting said fuel gas from the fuel tank 45 to the canister 46, a purge channel pipe 48 for conducting the fuel gas desorbed from the canister 46 to the surge tank 41b, and a purge control valve 49 disposed in the purge channel pipe 48. The purge control valve 49 is configured so as to vary the open cross-section area of the purge channel pipe 48.

The canister 46 is configured so as to emit the fuel gas absorbed by the absorber 46a housed in a case to the surge tank 41b through the purge channel pipe 48 during the period at which the purge control valve 49 is open. In addition, an air port 46b is formed in the case of the canister 46, so that the fuel gas leaked (desorbed) from the absorber 46a can be released to air through the air port 46b. Thus, the internal combustion engine 10 comprises a “purge system” to conduct the fuel gas generated by the evaporation of the fuel retained in the fuel tank 45 to the intake channel.

Referring to FIG. 1 again, the exhaust system 50 comprises an exhaust manifold 51 comprising multiple branch portions with one end connected to the exhaust port 34 of each cylinder, an exhaust pipe 52 connected to a gathering portion which is each other end of the multiple branch portions of the exhaust manifold 51 and at which all the branch portions gather together (exhaust gas gathering portion of the exhaust manifold 51), an upstream catalyst (three-way catalyst) 53 disposed in the exhaust pipe 52, and a downstream catalyst (three-way catalyst), not shown, disposed below the upstream catalyst 53 in the exhaust pipe 52. The exhaust ports 34, the exhaust manifold 51 and the exhaust pipe 52 constitute an exhaust channel. Thus, the upstream catalyst 53 is disposed in the gathering exhaust channel composed of gathered respective exhaust channels extending from multiple cylinders.

Further, the internal combustion engine 10 comprises an exhaust gas recirculation pipe 54 constituting an external EGR channel, and an EGR valve 55. One end of the exhaust gas recirculation pipe 54 is connected to the gathering portion of the exhaust manifold 51. Other end of the exhaust gas recirculation pipe 54 is connected to the surge tank 41b. The EGR valve 55 is disposed in the exhaust gas recirculation pipe 54. The EGR valve 55 is configured so as to vary the open cross-section area of the exhaust gas recirculation pipe 54. Thus, the internal combustion engine 10 comprises an “Exhaust Gas Recirculation (EGR) system.”

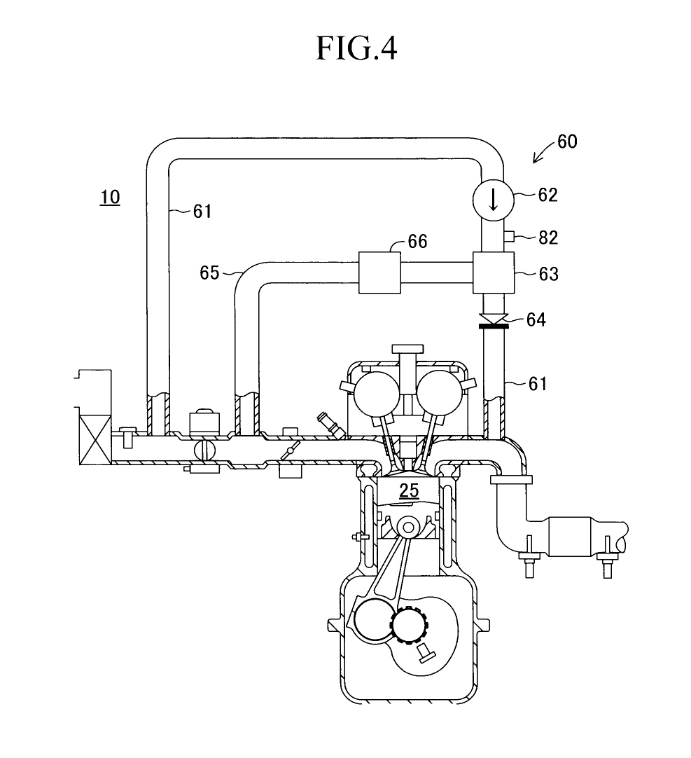

Also, as shown in FIG. 1 and FIG. 4, the internal combustion engine 10 comprises a secondary air supply unit 60. The secondary air supply unit 60 comprises a secondary air supply channel 61 to make the intake channel above the throttle valve 43 and the gathering exhaust channel above the catalyst 53 in communication with each other, an air pump 62 interposed in the secondary air supply channel 61, an air switching valve (ASV) 63 interposed below the air pump 62 in the secondary air supply channel 61, and a reed valve 64 (check valve to allow only a flow from upstream to downstream) interposed below the ASV 63 in the secondary air supply channel 61. In addition, the secondary air supply unit 60 comprises a negative-pressure introduction channel 65 for introducing the negative-pressure within the surge tank 41b into the ASV 63, and an electromagnetic valve 66 interposed in the negative-pressure introduction channel 65.

The ASV 63 is in an open state when the electromagnetic valve 66 is in an open state and the negative-pressure within the surge tank 41b is introduced, and is in a close state when the electromagnetic valve 66 is in a close state and said negative-pressure within the surge tank 41b is not introduced. Namely, in the secondary air supply unit 60, air is introduced into the gathering exhaust channel above the catalyst 53 by putting the air pump 62 into operation and making the electromagnetic valve 66 in the open state. Thus, the internal combustion engine 10 comprises a “secondary air supply system.”

On the other hand, the internal combustion engine 10 comprises an air flow meter 71, a throttle position sensor 72, a coolant temperature sensor 73, a crank position sensor 74, an intake cam position sensor 75, an exhaust cam position sensor 76, an upstream air-fuel ratio sensor 77, a downstream air-fuel ratio sensor 78, an accelerator opening sensor 79, an SCV opening sensor 81, and a pressure sensor 82 (refer to FIG. 4).

The air flow meter 71 detects the mass flow rate of the intake air flowing through the intake pipe 42. The throttle position sensor 72 detects the opening of the throttle valve 43 (throttle valve opening). The coolant temperature sensor 73 detects the temperature of the coolant of the internal combustion engine 10. The crank position sensor 74 detects the phase (alteration) of the rotation angle of the crank shaft 24. This detection result represents the engine revolution speed NE.

The intake cam position sensor 75 detects the phase (alteration) of the rotation angle of the intake cam shaft. Based on the signals from the crank position sensor 74 and the intake cam position sensor 75, the absolute crank angle CA based on the compression top dead center of the base cylinder (for example, the first cylinder) is acquired. This absolute crank angle CA is set at “0° crank angle” at the compression top dead center of the base cylinder, and increases until 720° crank angle in accordance with the rotation angle of the crank shaft 24, and is set again at 0° crank angle at that point. The exhaust cam position sensor 76 detects the phase (alteration) of the rotation angle of the exhaust cam shaft.

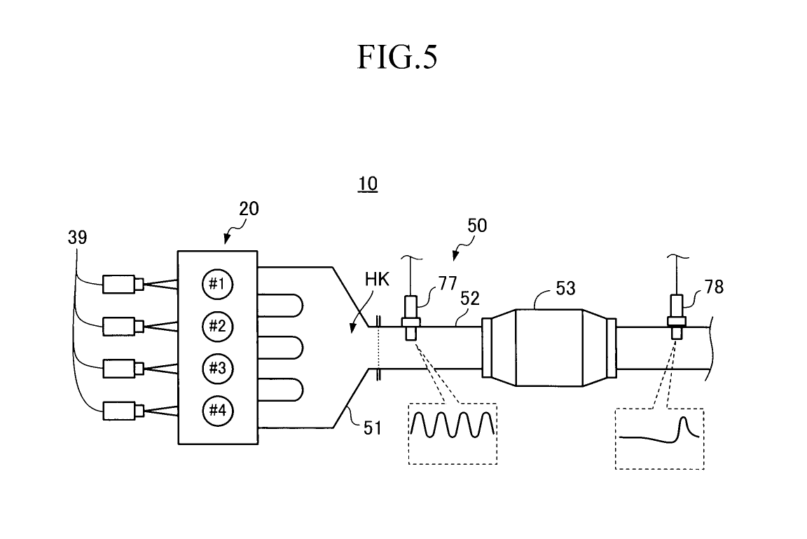

As shown also in FIG. 5, the upstream air-fuel ratio sensor 77 (air-fuel ratio sensor in the present invention) is disposed above the upstream catalyst 53 in the gathering exhaust channel below the gathering portion HK (exhaust gas gathering portion) of the exhaust manifold 51. The upstream air-fuel ratio sensor 77 is, for example, the “limiting current-type large area air-fuel ratio sensor comprising a diffusion resistance layer” disclosed in Japanese Patent Application Laid-Open (kokai) No. 11-72473, Japanese Patent Application Laid-Open (kokai) No. 2000-65782, and Japanese Patent Application Laid-Open (kokai) No. 2004-69547.

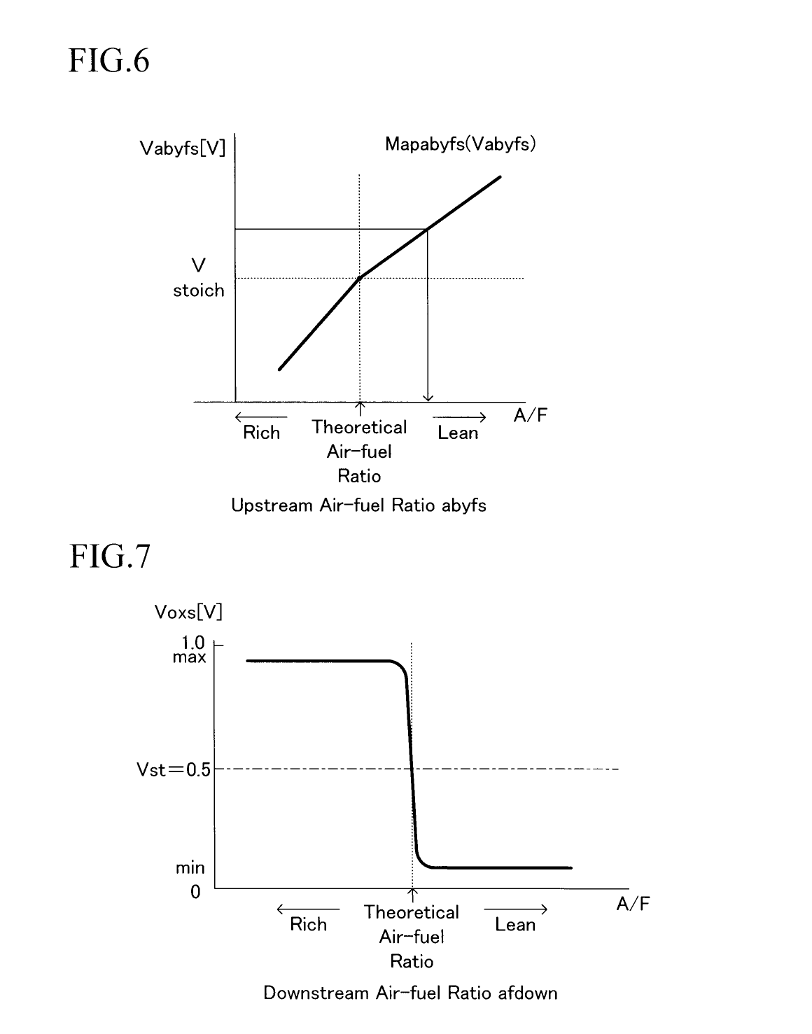

Hereinafter, the exhaust gas passing through the gathering exhaust channel is referred to as the “mixed exhaust gas.” The mixed exhaust gas is the gas obtained by mixing exhaust gases exhausted from respective cylinders. The upstream air-fuel ratio sensor 77 generates an output value Vabyfs (V) corresponding to the air-fuel ratio in the mixed exhaust gas flowing into the upstream catalyst 53. This output value Vabyfs(V) is converted into the air-fuel ratio (hereinafter, referred to as “detected air-fuel ratio”) abyfs represented by the output value Vabyfs (V) by utilizing the air-fuel ratio conversion table (map) Mapabyfs shown in FIG. 6.

Referring to FIG. 1 and FIG. 5 again, the downstream air-fuel ratio sensor 78 is disposed below the upstream catalyst 53 and above the downstream catalyst in the gathering exhaust channel. The downstream air-fuel ratio sensor 78 is a well-known electromotive force-type oxygen concentration sensor (well-known concentration cell-type oxygen concentration sensor using stabilized zirconia). The downstream air-fuel ratio sensor 78 generates an output value Voxs (V) corresponding to the air-fuel ratio in the mixed exhaust gas flowing out of the upstream catalyst 53 (accordingly, the time average of the air-fuel ratio in the air-fuel mixture supplied to an engine).

As shown in FIG. 7, the output value Voxs (V) comes to the maximum output value max (for example, about 0.9 V) when the air-fuel ratio is richer than the theoretical air-fuel ratio, comes to the minimum value min (for example, about 0.1 V) when the air-fuel ratio is leaner than the theoretical air-fuel ratio, and comes to the approximately intermediate value Vst (for example, about 0.5 V) between the maximum output value max and the minimum value min when the air-fuel ratio is the theoretical air-fuel ratio. Further, this output value Voxs rapidly changes from the maximum value max to the minimum value min when the air-fuel ratio changes from an air-fuel ratio richer than the theoretical air-fuel ratio to an air-fuel ratio leaner than the theoretical air-fuel ratio, and rapidly changes from the minimum value min to the maximum value max when the air-fuel ratio changes from an air-fuel ratio leaner than the theoretical air-fuel ratio to an air-fuel ratio richer than the theoretical air-fuel ratio.

Referring to FIG. 1 again, the accelerator opening sensor 79 detects the operation amount of an accelerator pedal AP operated by a driver (accelerator pedal operation amount). The SCV opening sensor 81 detects the opening of the SCV 44 (SCV opening). The pressure sensor 82 (refer to FIG. 4) is configured so as to detect the pressure within the secondary air supply channel 61 above the ASV 63.

An electric control unit 90 is a well-known microcomputer comprising a CPU 91, a ROM 92 preliminarily memorizing a program executed by the CPU 91, various tables (maps, functions), constants and the like, a RAM 93 in which the CPU 91 temporarily stores data according to need, and a backup RAM 94, as well as an interface 95 comprising an AD converter, and the like” connected with one another.

The interface 95 is connected with the sensors 71 to 82, and supplies the signals from the sensors to the CPU 91. Further, the interface 95 is configured so as to deliver driving signals (directing signals) to the actuator 33a, the actuator 36a, the igniters 38 in respective cylinders, the fuel injection valves 39 disposed in accordance with respective cylinders, the throttle valve actuator 43a, the SCV actuator 44a, the purge control valve 49, the EGR valve 55, and the electromagnetic valve 66 and the like.

(Air-Fuel Ratio Feedback Control)

Next, the brief summary of the air-fuel ratio feedback control by the present unit will be described. Based on the output value Vabyfs of the upstream air-fuel ratio sensor 77 and the output value Voxs of the downstream air-fuel ratio sensor 78, the present unit feedback controls the air-fuel ratio in the mixed exhaust gas so as to make it coincide with the theoretical air-fuel ratio.

One example of the feedback control includes the following. Namely, by PID process on the deviation between the output value Voxs of the downstream air-fuel ratio sensor 78 and the target value Vst corresponding to the theoretical air-fuel ratio, a feedback correction value (sub-feedback correction amount) is obtained. By applying the value obtained by correcting the output value Vabyfs of the upstream air-fuel ratio sensor 77 with the sub-feedback correction amount to the air-fuel ratio conversion table Mapabyfs shown in FIG. 6, an apparent air-fuel ratio is obtained. By PID process on the deviation between this apparent air-fuel ratio and the theoretical air-fuel ratio, an air-fuel ratio feedback amount is obtained. This air-fuel ratio feedback amount is a common value to all the cylinders.

Fuel whose amount is obtained by correcting “basic fuel injection amount obtained based on the engine revolution speed NE and the theoretical air-fuel ratio” with the air-fuel ratio feedback amount is respectively injected from the fuel injection valve 39 in each cylinder. Thus, by respectively adjusting the amount of fuel injected from each fuel injection valve 39 based on the air-fuel ratio feedback amount which is common to all the cylinders, the air-fuel ratio in the mixed exhaust gas is feedback controlled.

(Emission Amount Reduction Control)

Next, the brief summary of the emission reduction control by the present unit will be described. As the emission reduction control, the present unit executes a purge control, an EGR control, an Al incremental control, a cold VVT control, a catalyst warm-up delay angle control, and an SCV control. Hereinafter, each control will be briefly described in sequence.

### <Purge Control>

The purge control is performed by utilizing the above-mentioned purge system (refer to FIG. 3). The purge control is a control to conduct the fuel gas generated by the evaporation of the fuel retained in the fuel tank 45 to the intake channel by keeping the purge control valve 49 in the open state under a certain condition, and to decrease the amount of the fuel injected from each fuel injection valve 39 (from the amount adjusted with the above-mentioned air-fuel ratio feedback amount).

The fuel gas is conducted to the intake channel for the purpose of suppressing the leak of the fuel gas (i.e., unburned materials, HC and the like) from the inside of the canister 46 through the air port 46b. The amount of the fuel injection is decreased by the amount of the fuel gas conducted to the intake channel. The amount of the fuel gas conducted to the intake channel can be estimated by using one of well-known techniques. Thus, according to the purge control, while the air-fuel ratio is maintained at (adjacent) the theoretical air-fuel ratio, the amount of unburned materials (such as HC) emitted from the canister 46 can be reduced.

### <EGR Control>

The EGR control is performed by utilizing the above-mentioned “EGR system.” The EGR control is a control to conduct the exhaust gas in the exhaust channel to the intake channel by putting the EGR valve 55 into the open state under a certain condition. This operation may be referred to as an external EGR.

The fuel gas within the exhaust channel is conducted to the intake channel for the purpose of suppressing the generation of nitrogen oxides (NOx) due to combustion by raising the proportion of the inactive gas in the gas within the combustion chamber 25 to decrease the highest combustion temperature. Thus, according to the EGR control, the amount of nitrogen oxides emitted from the combustion chamber 25 can be reduced.

### <Al Incremental Control>

The Al incremental control is performed by utilizing the above-mentioned “secondary air supply system” (refer to FIG. 4). The Al incremental control is a control to introduce air into the gathering exhaust channel above the upstream catalyst 53 by putting the electromagnetic valve 66 into the open state (accordingly, putting the ASV 63 in the open state) and operating the air pump 62 under a certain condition, and to increase the amount of the fuel injected from each fuel injection valve 39 (from the amount adjusted with the above-mentioned air-fuel ratio feedback amount).

Air is conducted to the gathering exhaust channel above the upstream catalyst 53 for the purpose of burning the unburned materials (such as HC) in this portion to promote the warm-up of the upstream catalyst 53. The amount of the fuel injection is increased by the amount required to be burned with the air introduced into the gathering exhaust channel above the upstream catalyst 53 (for example, the value obtained by dividing the amount of the introduced air by the theoretical air-fuel ratio). The amount of the introduced air can be estimated by using one of well-known techniques. Thus, according to the Al incremental control, when the temperature of the catalyst is low, for example, just after the cold starting of the internal combustion engine 10, the catalyst can be activated early and the amount of unburned materials (such as HC, CO) and nitrogen oxides (NOx) in the exhaust gas emitted from the catalyst can be reduced.

### <Cold VVT Control>

The cold VVT control is performed by utilizing the above-mentioned VVT system. The cold VVT control is a control to adjust the opening and closing timings of the intake valves 32 and/or the opening and closing timings of the exhaust valves 35 (as compared with those during the ordinary non-cold VVT control) under a certain condition to increase the amount of the burned gas in the combustion chamber 25 spitting back to the intake channel via the periphery of the intake valves 32 (as compared with those during the ordinary non-cold VVT control) (spit-back amount of burned gas), and to decrease the amount of the fuel injected from each fuel injection valve 39 (from the amount adjusted with the above-mentioned air-fuel ratio feedback amount). The operation to increase the spit-back amount of burned gas may be referred to as an internal EGR. The opening and closing timings of the intake valves 32 and/or the opening and closing timings of the exhaust valves 35 during the ordinary non-cold VVT control is determined based on the operational state of the internal combustion engine 10 (based on the output results of the above-mentioned various sensors).

The burned gas in the combustion chamber 25 is conducted to the intake channel for the purpose of promoting the warm-up of the intake channel to promote the atomization of liquid fuel adhering to the intake channel. The amount of the fuel injection is decreased by the increment of the atomized fuel gas. The increment of the atomized fuel gas can be estimated by using one of well-known techniques. Thus, according to the cold VVT control, when the temperature of the intake channel is low, for example, just after the cold starting of the internal combustion engine 10, the atomization of the injected fuel can be promoted to reduce the amount of unburned materials (such as HC, CO) emitted from the combustion chamber 25 while the air-fuel ratio is maintained at (adjacent) the theoretical air-fuel ratio.

### <Catalyst Warm-Up Delay Angle Control>

The catalyst warm-up delay angle control is a control to delay the ignition timing of the injection plugs 37 (as compared with those during the ordinary non-catalyst warm-up delay angle control) under a certain condition. The ignition timing during the ordinary non-catalyst warm-up delay angle control is determined based on the operational state of the internal combustion engine 10 (based on the output results of the above-mentioned various sensors).

The ignition timing is delayed for the purpose of promoting the warm-up of the upstream catalyst 53 by delaying the combustion timing of fuel to raise the temperature of the exhaust gas flowing into the catalyst. Thus, according to the catalyst warm-up delay angle control, when the temperature of the catalyst is low, for example, just after the cold starting of the internal combustion engine 10, the catalyst can be activated early and the amount of unburned materials (such as HC, CO) and nitrogen oxides (NOx) in the exhaust gas emitted from the catalyst can be reduced.

### <SCV Control>

The SCV control is performed by utilizing the above-mentioned intake flow adjusting system. The SCV control is a control to switch (open and/or close) the SCV 44 in accordance with the operational state of the internal combustion engine 10. The SCV 44 is put into the close state for the purpose of promoting the atomization of the injected fuel by raising the flow rate of the intake gas to raise the flow rate of swirl. The SCV 44 is put into the open state for the purpose of decreasing the intake resistance to inhale more air into the combustion chamber 25. Thus, according to the SCV control, when fuel is difficult to be atomized and the flow rate of swirl is low, for example, in an idling state just after the cold starting of the internal combustion engine 10, the atomization of the injected fuel can be promoted by putting the SCV 44 into the close state, and thereby the amount of unburned materials (such as HC, CO) in the exhaust gas emitted from the combustion chamber 25 can be reduced. In addition, in other cases, more air can be inhaled into the combustion chamber 25 by putting the SCV 44 into the open state, and thereby the maximum power of the internal combustion engine 10 can be improved.

(Air-Fuel Ratio Imbalance Among Cylinders)

Next, the case where the air-fuel ratio imbalance among cylinders occurs will be described. The “air-fuel ratio imbalance among cylinders” refers to the variability of the air-fuel ratios among cylinders. The air-fuel ratio imbalance among cylinders can occur, for example, due to the variability of the actual injection amounts from fuel injection valves 39 among cylinders, the variability of the actual maximum lifting heights of intake valves 39 among cylinders, the variability of distribution of the exhaust gas circulated to the intake channel by means of EGR system into respective cylinders, and the like.

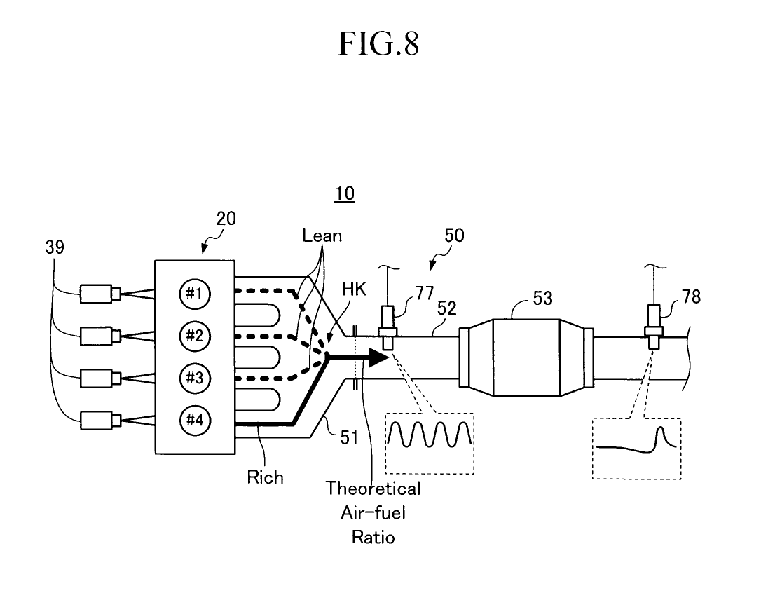

As shown in FIG. 8, when the “air-fuel ratio imbalance among cylinders” occurs, even though the air-fuel ratio in the mixed exhaust gas coincides with the theoretical air-fuel ratio, a cylinder with an air-fuel ratio richer than the theoretical air-fuel ratio (rich cylinder) and a cylinder with an air-fuel ratio leaner than the theoretical air-fuel ratio (lean cylinder) necessarily occur. In FIG. 8, as one example, the case where the fourth cylinder is the “rich cylinder” and the first to third cylinders are the “lean cylinder” is shown.

The air-fuel ratio imbalance among cylinders shown in FIG. 8 can occur, for example, when the fuel injection valves 39 in the first to third cylinders are in a normal state where “the fuel whose amount is equal to the directed amount is injected” and only the fuel injection valves 39 in the fourth cylinder is in an abnormal state where “the fuel whose amount is excessive over the directed amount is injected.” Namely, in this case, only the air-fuel ratio in the forth cylinder widely changes to rich side. Thereby, the air-fuel ratio in the mixed exhaust gas passing through the gathering exhaust channel (the average of the air-fuel ratios for all cylinders) comes to be richer than the theoretical air-fuel ratio. Accordingly, by means of the above-mentioned “air-fuel ratio feedback amount” which is common to all the cylinders, the air-fuel ratio in the fourth cylinder is varied to lean side so as to be moved closer to the theoretical air-fuel ratio, and concurrently the air-fuel ratio in other three cylinders are varied to lean side so as to be distanced from the theoretical air-fuel ratio. As the result of this, the air-fuel ratio in the mixed exhaust gas passing through the gathering exhaust channel is made approximately coincide with the theoretical air-fuel ratio.

However, the air-fuel ratio in the fourth cylinder is still maintained richer than the theoretical air-fuel ratio, and the air-fuel ratio in other three cylinders are is maintained leaner than the theoretical air-fuel ratio. From the above, the fourth cylinder becomes the “rich cylinder” and the first to third cylinders become the “lean cylinders.”

Thus, when the air-fuel ratio imbalance among cylinders occurs, the combustion state of the air-fuel mixture in each cylinder comes to a combustion state different from complete combustion. As the result of this, the amount of emission (amount of unburned materials and amount of nitrogen oxides) emitted from each cylinder increases. Therefore, even though the air-fuel ratio in the mixed exhaust gas passing through the gathering exhaust channel (the average of the air-fuel ratios for all cylinders) is the theoretical air-fuel ratio, the three-way catalyst cannot clean up the increased emission, and consequently the emission contained in the exhaust gas could increase.

(Negative Effect by Emission Reduction Control on Occurrence of Air-Fuel Ratio Imbalance Among Cylinders)

Next, the negative effect in the case where the above-mentioned various emission reduction controls are executed when the air-fuel ratio imbalance among cylinders occurs will be discussed in sequence.

### <Purge Control>

As mentioned above, the amount of fuel injection in each cylinder is decreased by the estimate value of the amount of the fuel gas conducted to the intake channel. It is conceived that the estimate accuracy of this estimate value is likely to be inaccurate when the air-fuel ratio imbalance among cylinders occurs. Accordingly, when this estimate value is estimated larger than its realistic value, especially in the “lean cylinder” with low combustion limit, problems such as excessively lean air-fuel ratio due to the excessive decrease in the amount of fuel injection causing misfire and the like can occur.

### <EGR Control>

As mentioned above, when the EGR control is executed, the proportion of the inactive gas in the gas within the combustion chamber arises. This means that the combustion is likely to become instable. Accordingly, especially in the “lean cylinder” with low combustion limit, problems such as excessively instable combustion causing misfire and the like can occur.

### <Al Incremental Control>

As mentioned above, in the Al incremental control, the amount of fuel injection in each cylinder is increased by the value obtained by dividing the estimate value of the amount of the air introduced into the gathering exhaust channel above the upstream catalyst 53 by the theoretical air-fuel ratio. It is conceived that the estimate accuracy of this estimate value is likely to be inaccurate when the air-fuel ratio imbalance among cylinders occurs. Accordingly, when this estimate value is estimated larger than its realistic value, especially in the “rich cylinder”, problems such as excessively rich air-fuel ratio due to the excessive increase in the amount of fuel injection causing misfire and the like can occur.

### <Cold VVT Control>

As mentioned above, in the cold VVT control, the amount of fuel injection in each cylinder is decreased by the estimate value of the increment of the atomized fuel gas. It is conceived that the estimate accuracy of this estimate value is likely to be inaccurate when the air-fuel ratio imbalance among cylinders occurs. Accordingly, when this estimate value is estimated larger than its realistic value, especially in the “lean cylinder” with low combustion limit, problems such as excessively lean air-fuel ratio due to the excessive decrease in the amount of fuel injection causing misfire and the like can occur.

### <Catalyst Warm-Up Delay Angle Control>

As mentioned above, when the catalyst warm-up delay angle control is executed, the ignition timing is delayed. This means that the combustion is likely to become instable. Accordingly, especially in the “lean cylinder” with low combustion limit, problems such as excessively instable combustion causing misfire and the like can occur.

### <SCV Control>

As mentioned above, in the SCV control, for example, in the case that is not the idling state just after the cold starting, the SCV 44 is put into the open state. Putting the SCV 44 into the open state means that the flow rate of the intake gas becomes low (accordingly, the flow rate of swirl becomes low) and the combustion is likely to be instable. Accordingly, especially in the “lean cylinder” with low combustion limit, problems such as excessively instable combustion causing misfire and the like can occur.

As described above, in the case where the above-mentioned various emission reduction controls are executed when the air-fuel ratio imbalance among cylinders occurs, in the “lean cylinder” or “rich cylinder,” negative effects such as the occurrence of misfire and the like can occur. Accordingly, in order to suppress the occurrence of misfire and the like, it is preferred to “limit” or “prohibit” the execution of the above-mentioned various emission reduction controls when the air-fuel ratio imbalance among cylinders occurs. This requires the detection of the occurrence of the air-fuel ratio imbalance among cylinders.

(Detection of Air-fuel Ratio Imbalance among Cylinders)

Next, the detection of the air-fuel ratio imbalance among cylinders will be described. In order to detect the air-fuel ratio imbalance among cylinders, it is necessary to acquire the index value representing the difference (degree of disbalance, degree of discrepancy) among the cylinder-by-cylinder air-fuel ratios. The cylinder-by-cylinder air-fuel ratio refers to the air-fuel ratio in the air-fuel mixture supplied to each cylinder. Hereinafter, this index value is referred to as “imbalance index value.” In addition, as a matter of explanatory convenience, the “period passed by the crank angle required to finish one combustion stroke in each of all cylinders (all cylinders emitting exhaust gas which arrives at the upstream air-fuel ratio sensor 77)” is referred to as a “unit combustion cycle period.” In case of a 4-cylindered 4-cycle engine, the unit combustion cycle period is 720° crank angle.

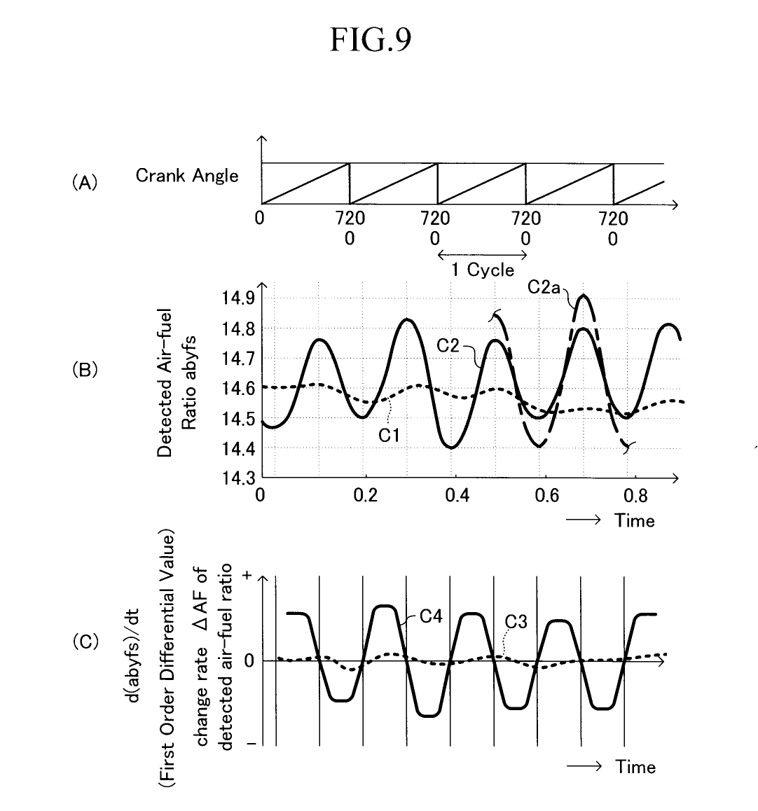

FIG. 9 (B) shows one example of the transition of the detected air-fuel ratio (air-fuel ratio obtained by applying the output value Vabyfs of the upstream air-fuel ratio sensor 77 to the air-fuel ratio conversion table Mapabyfs shown in FIG. 6) in case of a 4-cylindered 4-cycle engine. At the upstream air-fuel ratio sensor 77, the exhaust gases from respective cylinders arrive in order of ignition (therefore, in order of exhaust). When the air-fuel ratio imbalance among cylinders does not occur, the cylinder-by-cylinder air-fuel ratios in all cylinders are approximately identical to one another. Accordingly, the detected air-fuel ratio abyfs in the case where the air-fuel ratio imbalance among cylinders does not occur modulates, for example, as shown by the broken line C1 in FIG. 9 (B). Namely, when the air-fuel ratio imbalance among cylinders does not occur, the waveform of the detected air-fuel ratio abyfs is approximately flat.

On the contrary, since the “rich cylinder” and the “lean cylinder” necessarily exist when the air-fuel ratio imbalance among cylinders occurs, the difference among the cylinder-by-cylinder air-fuel ratios in all cylinders occurs. Accordingly, the detected air-fuel ratio abyfs in the case where the air-fuel ratio imbalance among cylinders occurs widely varies, for example, in a cycle of 720° crank angle (i.e., the unit combustion cycle period) as shown by the solid line C2 in FIG. 9 (B).

As understood from the above, when the air-fuel ratio imbalance among cylinders occurs, the detected air-fuel ratio abyfs widely varies in a cycle of the unit combustion cycle period. Further, the larger the difference among the cylinder-by-cylinder air-fuel ratios is, the larger the amplitude of the detected air-fuel ratio abyfs becomes. For example, when the difference among the cylinder-by-cylinder air-fuel ratios is larger than that in the case where the detected air-fuel ratio abyfs modulates as shown by the solid line C2 in FIG. 9 (B), the detected air-fuel ratio abyfs modulates as shown by the dashed-dotted line C2a in FIG. 9 (B).

Accordingly, it is preferred that the imbalance index value is a value reflecting such a transitory condition of the detected air-fuel ratio abyfs. Namely, it is preferred that the imbalance index value is a value which increases or decreases in accordance with the increase in the difference among the cylinder-by-cylinder air-fuel ratios and is acquired based on the output value Vabyfs of the upstream air-fuel ratio sensor 77 (accordingly, the detected air-fuel ratio abyfs). As one example of the imbalance index value, the locus length of the output value Vabyfs of the upstream air-fuel ratio sensor 77 (the detected air-fuel ratio abyfs) can be exemplified.

Also, as the imbalance index value, for example, a value based on the “amount of change per unit time of the detected air-fuel ratio abyfs” can be used. It can be said that the “amount of change per unit time of the detected air-fuel ratio abyfs” is a temporal differential value d(abyfs)/dt of the detected air-fuel ratio abyfs when the unit time is an extremely short time, for example, about 4 m seconds. Accordingly, the “amount of change per unit time of the detected air-fuel ratio abyfs” may be referred to as a “change rate ΔAF of detected air-fuel ratio.”

As shown by the broken line C3 in FIG. 9 (C), in the case where the imbalance of air-fuel ratio among cylinders does not occur, the absolute value of the change rate ΔFF of detected air-fuel ratio is small. On the other hand, as shown by the solid line C4 in FIG. 9 (C), in the case where the imbalance of air-fuel ratio among cylinders occurs, the absolute value of the change rate ΔFF of detected air-fuel ratio becomes large. Further, the absolute value of the change rate ΔFF of detected air-fuel ratio becomes larger in accordance with the increase in the difference among the cylinder-by-cylinder air-fuel ratios.

In the present unit, as the imbalance index value, a value based on the absolute value of the change rate ΔFF of detected air-fuel ratio (for example, the absolute value itself of the change rate ΔFF of detected air-fuel ratio obtained every time when a sampling time ts has passed, the average value of multiple absolute values of the change rate ΔFF of detected air-fuel ratio, and the maximum value among multiple absolute values of the change rate ΔFF of detected air-fuel ratio, and the like) is used. This is based on the fact that the change rate ΔFF of detected air-fuel ratio is unlikely to be affected by the engine revolution speed NE, as compared with the locus length of the detected air-fuel ratio abyfs.

(Suppression or Prohibition of Emission Reduction Control on Occurrence of Imbalance of Air-Fuel Ratios Among Cylinders)

Taking the above into account, in the present unit, in the case where the imbalance of air-fuel ratio among cylinders is judged to be occurring, when the condition for the above-mentioned various emission reduction controls to be executed is satisfied, the execution of the emission reduction control is “limited” or “prohibited.”

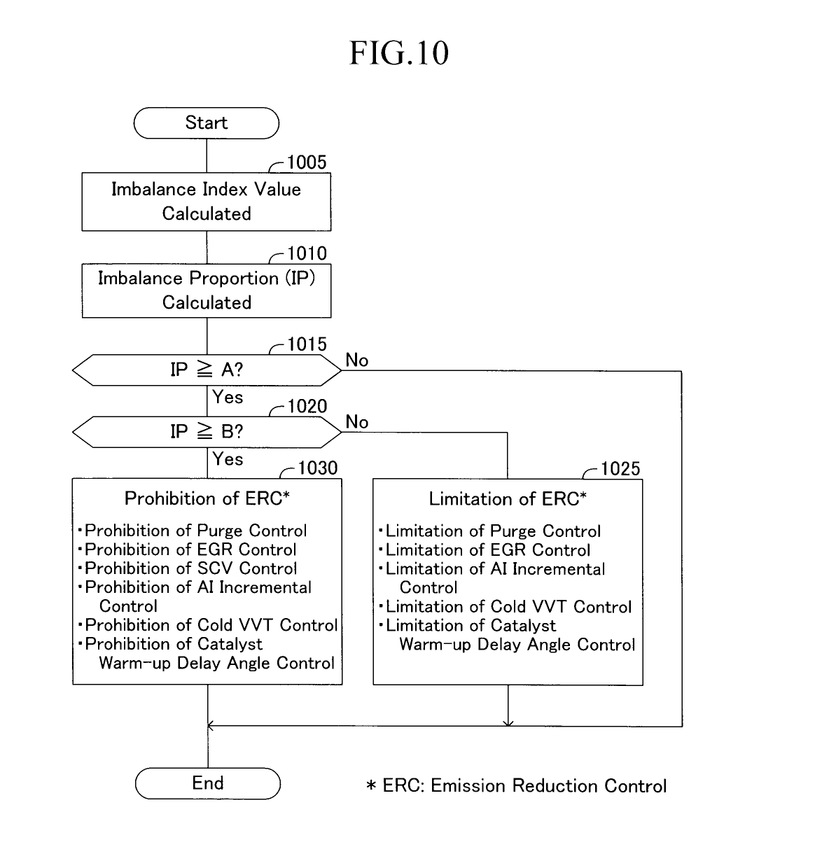

FIG. 10 is a flowchart showing one example of the flow of processes according to the “suppression or prohibition of the emission reduction control on the occurrence of the imbalance of air-fuel ratios among cylinders.” In this example, first, in step 1005, the imbalance index value X1 is calculated.

Specifically, the detected air-fuel ratio abyfs is newly acquired every time when the sampling time ts (for example, 4 m seconds) has passed. Every time when the new detected air-fuel ratio abyfs is calculated (i.e., every time when the sampling time is has passed), the change rate ΔFF of detected air-fuel ratio is acquired by subtracting the previous detected air-fuel ratio from the current detected air-fuel ratio. The average value ΔFFave of multiple absolute values of the change rate ΔFF of detected air-fuel ratio acquired during a predetermined period is calculated. It is preferred that this predetermined period is the above-mentioned unit combustion cycle period (720° crank angle in case of a 4-cylindered 4-cycle engine).

The average value ΔFFave can be described as the “average value of the absolute values of the change rate ΔFF of detected air-fuel ratio during one unit combustion cycle period.” This average value ΔFFave is respectively acquired for each of multiple unit combustion cycle periods. The average value of thus obtained multiple average value ΔFFave's is acquired as an imbalance index value X1. This imbalance index value X1 is a value to increase in accordance with the increase in the difference among the cylinder-by-cylinder air-fuel ratios.

Next, in step 1010, an imbalance index value Y1 is calculated. In this example, the imbalance index value Y1 (%) is obtained, for example, in accordance with an equation: Y1=(X1−P1)/(Q1−P1), wherein the previously obtained “value of the imbalance index value X1 in the case where the imbalance of air-fuel ratio among cylinders does not occur (when the difference among the cylinder-by-cylinder air-fuel ratios is zero)” is defined as P1, and the “value of the imbalance index value X1 in the case where the degree of the imbalance of air-fuel ratio among cylinders is maximum (when the difference among the cylinder-by-cylinder air-fuel ratios is maximum)” is defined as Q1. Namely, the imbalance index value Y1 comes to “0%” when the imbalance of air-fuel ratio among cylinders does not occur, and comes to “100%” when the degree of the imbalance of air-fuel ratio among cylinders is the maximum.

Subsequently, in step 1015, it is judged whether the imbalance index value Y1 is a predetermined value A (%) or more, or not, and this process is immediately terminated when it is judged as “No.” On the other hand, when it is judged as “Yes,” in step 1020, it is judged whether the imbalance index value Y1 is a predetermined value B (%) or more, or not. The predetermined value B is larger than the predetermined value A. When A≦Y1<B is satisfied (“No” in step 1020), in step 1025, the execution of the emission reduction control is limited. On the other hand, when Y1≧B is satisfied (“Yes” in step 1020), in step 1030, the execution of the emission reduction control is prohibited. Herein, the fact that it is judged as “No” in step 1015 means that the imbalance of air-fuel ratio among cylinders is judged to be not occurring, and the fact that it is judged as “Yes” means that the imbalance of air-fuel ratio among cylinders is judged to be occurring.

Hereinafter, first, the “limitation of the execution of the emission reduction control” in step 1025 will be specifically described. In case of the purge control, the decrement of the amount of fuel injection is decreased. In addition to this, the opening of the purge control valve 49 may be decreased to decrease the amount (flow rate) of the fuel gas conducted to the intake channel. In case of the EGR control, the opening of the EGR valve 55 may be decreased to decrease the amount (flow rate) of the exhaust gas in the exhaust channel conducted to the intake channel. In case of the Al incremental control, the increment of the amount of fuel injection is decreased. In addition to this, the electromagnetic valve 66 (i.e., the ASV 63) may be adjusted to decrease the amount (flow rate) of the air conducted to the gathering exhaust channel. In case of the cold VVT control, the decrement of the amount of fuel injection is decreased. In addition to this, the opening and closing timings of the intake valves 32 and/or the exhaust valves 35 may be adjusted to decrease the spit-back amount of the burned gas. In case of the catalyst warm-up delay angle control, the delayed angle amount of ignition timing is decreased.

Next, the “prohibition of the execution of the emission reduction control” in step 1030 will be specifically described. In case of the purge control, the purge control is not performed. Namely, the purge control valve 49 is put into the close state, and the amount of fuel injection is set at the amount equal to the amount adjusted with the above-mentioned air-fuel ratio feedback amount. In case of the EGR control, the EGR control is not performed. Namely, the EGR valve 55 is put into the close state. In case of the SCV control, the SCV control is not performed, and the SCV 44 is maintained at the close state. In case of the Al incremental control, the Al incremental control is not performed. Namely, the electromagnetic valve 66 is put into the close state (i.e., the ASV 63 is put into the close state), and the amount of fuel injection is set at the amount equal to the amount adjusted with the above-mentioned air-fuel ratio feedback amount. In case of the cold VVT control, the cold VVT control is not performed. Namely, the opening and closing timings of the intake valves 32 and/or the exhaust valves 35 is set at the timings equal to the opening and closing timings in case of the non-cold VVT control, and the amount of fuel injection is set at the amount equal to the amount adjusted with the above-mentioned air-fuel ratio feedback amount. In case of the catalyst warm-up delay angle control, the catalyst warm-up delay angle control is not performed. Namely, the ignition timing is set at the timing equal to the ignition timing in case of the non-catalyst warm-up delay angle control.

As described above, in accordance with the embodiment according to the present invention (specifically, in accordance with the process shown in FIG. 10), when it is judged that the imbalance of air-fuel ratio among cylinders is happening (“Yes” in step 1015) (and when the condition for the emission reduction control to be executed is satisfied), the execution of the emission reduction control is “limited” (step 1025) or “prohibited” (step 1030). Accordingly, the occurrence of misfire and the like in the “lean cylinder” or the “rich cylinder” can be suppressed.

The present invention is not limited to the above-described embodiment, and various modifications can be adopted within the scope of the present invention. For example, although the imbalance index value X1 (a value increasing in accordance with the increase of the difference among the cylinder-by-cylinder air-fuel ratios) based on the temporal differential value (change rate ΔFF of detected air-fuel ratio) of the detected air-fuel ratio abyfs is used as an imbalance index value in the above-described embodiment, the value based on the second order differential value of the detected air-fuel ratio abyfs with respect to time may be used. Also, the locus length of the output value Vabyfs of the upstream air-fuel ratio sensor 77, or the locus length of the detected air-fuel ratio abyfs may be used. All of these values are the “values increasing in accordance with the increase of the difference among the cylinder-by-cylinder air-fuel ratios.”

Also, as the imbalance index value, the imbalance index value X2 obtained as described below may be used. Every time when the sampling time is (for example, 4 m seconds) has passed, the detected air-fuel ratio abyfs is newly acquired. The minimum value MIN is chosen among the multiple detected air-fuel ratios abyfs's acquired during a predetermined period. It is preferred that this predetermined period is the above-mentioned unit combustion cycle period (720° crank angle in case of a 4-cylindered 4-cycle engine).

The minimum value MIN can be described as the “minimum value among the detected air-fuel ratios abyfs's during one unit combustion cycle period.” This minimum value MIN is respectively acquired for each of multiple unit combustion cycle periods. The average value of thus obtained multiple minimum value MIN's is acquired as an imbalance index value X2. This imbalance index value X2 is a value to decrease in accordance with the increase in the difference among the cylinder-by-cylinder air-fuel ratios.

When the imbalance index value X2 is thus used, as an imbalance proportion, an imbalance proportion Y2 is calculated. Namely, the imbalance proportion Y2 (%) is obtained, for example, in accordance with an equation: Y2=(P2−X2)/(P2−Q2), wherein the previously obtained “value of the imbalance index value X2 in the case where the imbalance of air-fuel ratio among cylinders does not occur (when the difference among the cylinder-by-cylinder air-fuel ratios is zero)” is defined as P2, and the “value of the imbalance index value X2 in the case where the degree of the imbalance of air-fuel ratio among cylinders is maximum (when the difference among the cylinder-by-cylinder air-fuel ratios is maximum)” is defined as Q1. Namely, the imbalance proportion Y2 comes to “0%” when the imbalance of air-fuel ratio among cylinders does not occur, and comes to “100%” when the degree of the imbalance of air-fuel ratio among cylinders is the maximum.

Although the execution of the emission reduction control is limited (step 1025) when A≦Y1<B is satisfied (“No” in step 1020), and the execution of the emission reduction control is prohibited (step 1030) when Y1≧B is satisfied (“Yes” in step 1020), it may be configured so that the execution of the emission reduction control is always limited when Y1≧A is satisfied (“Yes” in step 1015).

In addition, although, in the above-described embodiment, the execution of the emission reduction control is “limited” or “prohibited” based on the magnitude of the imbalance proportion, the execution of the emission reduction control may be “limited” or “prohibited” based on the magnitude of the imbalance index value itself, without calculating the imbalance proportion.

What is claimed is:

1. A control unit for a multi-cylindered internal combustion engine which comprises:
an air-fuel ratio sensor which is disposed in a gathering exhaust channel composed of gathered respective exhaust channels extending from said multiple cylinders and generates an output value corresponding to the air-fuel ratio in mixed exhaust gas passing through said gathering exhaust channel;
multiple fuel injection valves which are disposed in accordance with each of said multiple cylinders and respectively inject fuel contained in an air-fuel mixture supplied to each combustion chamber of said multiple cylinders;
a feedback amount calculation means which calculates an air-fuel ratio feedback amount common to said multiple cylinders, based on the output value of said air-fuel ratio sensor, so that the air-fuel ratio in said mixed exhaust gas coincides with the theoretical air-fuel ratio;
a feedback control means which adjusts the amounts of fuel to be respectively injected from each of said multiple fuel injection valves based on said air-fuel ratio feedback amount and thereby feedback controls the air-fuel ratio in said mixed exhaust gas; and
a reduction control execution means which executes an emission reduction control that is a control for reducing the emission of hazardous substances emitted from a vehicle mounting said internal combustion engine thereon due to said internal combustion engine, and
an imbalance index value acquisition means which acquires an imbalance index value that increases or decreases in accordance with the increase in the degree of discrepancy among the multiple cylinder-by-cylinder air-fuel ratios which are the air-fuel ratios in air-fuel mixtures supplied into respective combustion chambers of said multiple cylinders, based on the output value of said air-fuel ratio sensor,
wherein said reduction control execution means is configured so as to limit the execution of said emission reduction control when said degree of discrepancy represented by said imbalance index value is large, as compared with when said degree of discrepancy is small.

2. A control unit for a multi-cylindered internal combustion engine according to claim 1, wherein:
said reduction control execution means is configured so as to execute, as said emission reduction control, a control to adjust the opening and closing timings of the intake valves and/or the exhaust valves of said internal combustion engine to increase the amount of the burned gas in said combustion chamber spitting back to the intake channel of said internal combustion engine via the periphery of said intake valves and decrease the amount of the fuel injected from said respective multiple fuel injection valves, and to decrease the decrement of the amount of the fuel injected from said respective multiple fuel injection valves in order to limit the execution of said emission reduction control.

3. A control unit for a multi-cylindered internal combustion engine according to claim 1, wherein:
said imbalance index value acquisition means is configured so as to acquire, as said imbalance index value, a value based on the temporal differential value of the detected air-fuel ratio which is the air-fuel ratio represented by the output value of said sir-fuel ratio sensor.

4. A control unit for a multi-cylindered internal combustion engine according to claim 1, wherein:
said reduction control execution means is configured so as to execute, as said emission reduction control, a control to conduct the fuel gas generated by the evaporation of the fuel retained in a fuel tank of said vehicle to an intake channel of said internal combustion engine and decrease the amount of the fuel injected from said respective multiple fuel injection valves, and to decrease the decrement of the amount of the fuel injected from said respective multiple fuel injection valves in order to limit the execution of said emission reduction control.

5. A control unit for a multi-cylindered internal combustion engine according to claim 1, wherein:
said reduction control execution means is configured so as to execute, as said emission reduction control, a control to conduct the exhaust gas in the exhaust channel of said internal combustion engine to an intake channel of said internal combustion engine, and to decrease the amount of said exhaust gas conducted to said intake channel in order to limit the execution of said emission reduction control.

6. A control unit for a multi-cylindered internal combustion engine according to claim 1, wherein:
said reduction control execution means is configured so as to execute, as said emission reduction control, a control to conduct air to the exhaust channel above the catalyst interposed in the exhaust channel of said internal combustion engine and increase the amount of the fuel injected from said respective multiple fuel injection valves, and to decrease the increment of the amount of the fuel injected from said respective multiple fuel injection valves in order to limit the execution of said emission reduction control.

7. A control unit for a multi-cylindered internal combustion engine according to claim 1, wherein:
said reduction control execution means is configured so as to execute, as said emission reduction control, a control to delay the ignition timing of the ignition plug of said internal combustion engine, and to decrease the delayed angle amount of said ignition timing in order to limit the execution of said emission reduction control.

8. A control unit for a multi-cylindered internal combustion engine according to claim 1, wherein:
said reduction control execution means is configured so as to limit the execution of said emission reduction control when said degree of discrepancy represented by said imbalance index value is the first degree or more, and less than the second degree which is larger than said first degree, and to prohibit the execution of said emission reduction control when said degree of discrepancy represented by said imbalance index value is said second degree or more.
